(19) United States
(12) Patent Application Publication
(10) Pub. No.: US 2004/0222755 A1
(43) Pub. Date: Nov. 11, 2004

(54) Antivibration apparatus and vehicle equipped with such antivibration apparatus

(76) Inventors: Borz Fariborzi, Grand Rapids, MI (US); Ali Rahbar, Comstock Park, MI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/431,999

(22) Filed: May 8, 2003

(51) Int. Cl. H02P 1/00; H02P 7/00; H02K 33/00

(52) U.S. Cl. 318/114; 318/128; 180/233; 180/245

(57) ABSTRACT

An antivibration apparatus for a rotary element, including an active mass vibration absorber actuated by a controller which generates a control signal by extracting harmonics of a rotation frequency of the rotary element. The controller determines a phase shift and an amplification as predetermined functions of the rotation frequency, and applies the phase shift and amplification to the harmonics of the input signal for obtaining the control signal.

### FIELD OF THE INVENTION

The invention relates to antivibration apparatuses for limiting vibrations of vibrating elements excited by at least a rotary assembly having a rotation frequency, and to vehicles equipped with such antivibration apparatuses.

### BACKGROUND OF THE INVENTION

An antivibration apparatus of this type, including passive mass dampers (i.e. oscillating masses mounted on rubber pads) was publicly used in particular in the Jeep Grand Sherokee Laredo (WG Jeep), in which the passive mass dampers were mounted on a bracket which itself was fixed at the rear end of the transfer case of the vehicle.

Such antivibration apparatus has a positive impact on the vibrations undergone by the powertrain of the vehicle, when the active mass dampers are tuned with a suitable frequency, and specially with the natural frequency of the powertrain.

However, such antivibration apparatus cannot produce an optimal response over a large frequency range, and may even produce an unfavorable response at certain frequencies.

Another drawback of such antivibration apparatus is that in some instances, the mass required for the passive mass damper to damp out the vibrations of the given system, may be so large that this solution becomes impractical.

### OBJECTS AND SUMMARY OF THE INVENTION

One objective of the present invention is to remedy these drawbacks, for a cost as limited as possible.

To this end, according to the invention, an antivibration device includes an active mass vibration absorber controlled by a controlling apparatus, said active mass vibration absorber including a support which is designed to be fixed to the vibrating element, a mass and an electromagnetic actuator adapted to move said mass relative to said support as a function of a control signal received from said controlling apparatus, said controlling apparatus including

a sensor apparatus adapted to detect positions of the rotary assembly during rotation thereof,

and a controller adapted to:

extract a filtered signal including at least one harmonic of said rotation frequency, from an input signal which is received from said sensor apparatus,

determine a phase shift and an amplification as predetermined functions of said rotation frequency,

and determine said control signal by applying said phase shift and amplification to said filtered signal.

In various embodiments of the invention, one may possibly have recourse in addition to one and/or other of the following arrangement:

said filtered signal includes several harmonics of said rotation frequency;

said filtered signal includes two harmonics, respectively of orders 2 and 2.5, of the rotation frequency;

the sensor apparatus is adapted to generate said input signal, in the form of a square signal;

the sensor apparatus is adapted to generate said input signal, in the form of a square signal;

said controller is adapted to determine said phase shift and amplification through predetermined look up tables representing said predetermined functions;

said mass is a permanent magnet.

Besides, another object of the invention is a vehicle comprising a motor which includes at least a rotary assembly having a rotation frequency, a vibrating element excited by said rotary assembly and an antivibration apparatus mounted on said vibrating element, said antivibration device including an active mass vibration absorber controlled by a controlling apparatus, said active mass vibration absorber including a support which is fixed to the vibrating element, a mass and an electromagnetic actuator adapted to move said mass relative to said support as a function of a control signal received from said controlling apparatus, said controlling apparatus including:

a sensor apparatus adapted to detect positions of the rotary assembly during rotation thereof,

and a controller adapted to:

extract a filtered signal including at least one harmonic of said rotation frequency, from an input signal which is received from said sensor apparatus,

determine a phase shift and an amplification as predetermined functions of said rotation frequency,

and determine said control signal by applying said phase shift and amplification to said first harmonic.

In one embodiment of the vehicle according to the invention, the motor drives a transfer case which itself drives front and rear wheels through front and rear shafts, the active mass absorber being mounted on the transfer case.

### BRIEF DESCRIPTION OF THE DRAWINGS

Other characteristics and advantages of the invention appear from the following detailed description of one of its embodiments, given by way of non-limiting example, and with reference to the accompanying drawings.

In the drawings:

FIG. 1 is a perspective schematic view of a vehicle including an antivibration apparatus according to one embodiment of the invention;

FIG. 2 is an elevation view of the antivibration apparatus mounted in the vehicle of FIG. 1, seen from the rear axle;

FIG. 3 is a side view of the antivibration apparatus of FIG. 2;

FIG. 4 is a bloc diagram illustrating the antivibration apparatus of FIG. 3;

FIG. 5 is a bloc diagram illustrating the controller of FIG. 4; and

FIG. 6 is a comparative diagram illustrating the accelerations undergone by the transfer case of the vehicle during use, in a particular example, with and without the antivibration apparatus in function.

In the various figures, the same references denote identical or similar elements.

The antivibration apparatus according to the invention is used for limiting vibrations of a vibrating element excited by at least a rotary assembly.

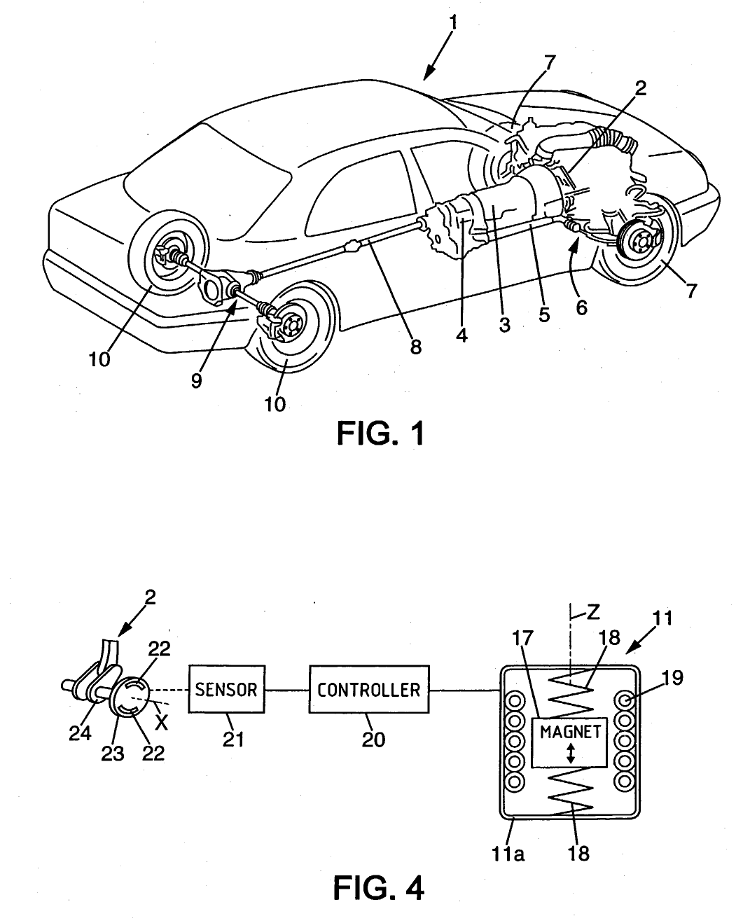

As shown in FIG. 1, the invention is applicable in particular, but not exclusively, to an automotive vehicle 1 including a motor 2 which drives a rotary assembly including in particular the crankshaft (not shown in FIG. 1), the vibrating element to be damped being for instance one element of the powertrain of the vehicle.

Such powertrain of the vehicle includes in particular a gear box 3 and may also include a transfer case 4 if the vehicle is a four wheel drive vehicle. This transfer case 4, which is driven by the motor 2 through the gear box 3, drives itself:

a front shaft 5 which extends forward to the front axle system 6 which drives the front wheels 7,

and a rear shaft 8 which extends rearward to a rear axle system 9 which drives the rear wheels 10.

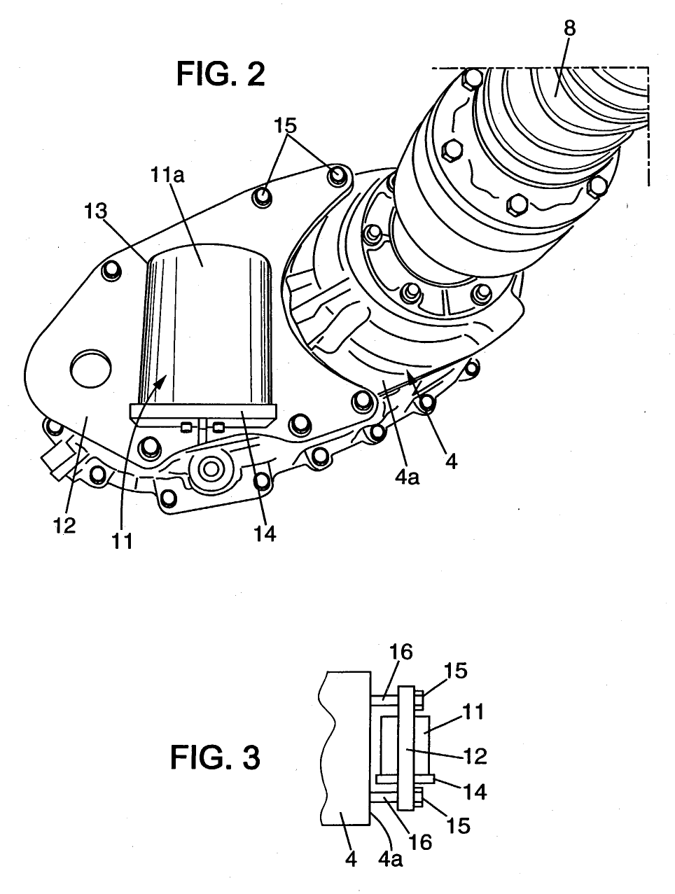

As shown in FIGS. 2 and 3, the antivibration apparatus according to the invention includes an active mass vibration absorber 11 which may be mounted to the rear end 4a of the transfer case 4 of the vehicle.

More precisely, in the example shown on FIGS. 2 and 3, the active mass absorber 11 is fixed on a support 12 which, in the example shown, is a metal bracket having a rectangular cutting 13 in which the active mass absorber 11 is inserted. Said active mass absorber 11 may have an external shape in the form of a cylinder of vertical axis, and may be fixed on a horizontal plate 14 which is secured to the bracket 12 at the lower end of the cutting 13.

In the example shown in FIGS. 2 and 3, the active mass absorber 11 and the plate 14 extend on both sides of the bracket 12, and said bracket is fixed at a distance from the rear end 4a of the transfer case, through a number of screws 15 which go through bushings 16 interposed between the bracket 12 and the rear end 4a of the transfer case.

As shown on FIG. 4, the active mass absorber 11 may include an outer casing 11a which contains an oscillating mass 17 mounted in the casing 11a through springs 18, so as to be able to oscillate at least in one direction, for instance in the vertical direction Z.

The casing 11a also contains an electrical coil 19 which is wound around axis Z, so that the mass 17, which may be constituted for instance by a permanent magnet, may oscillate inside said coil 19.

The coil 19 is controlled by a controlling apparatus which includes a controller 20 and a sensor apparatus, itself including a sensor 21 connected to controller 20. The sensor 21 is adapted to detect positions of the rotary assembly driven by the motor 2, and may for instance detect positions of a rotating pulley 23 which turns for instance with the crankshaft 24 of the motor.

In one embodiment of the invention, the sensor 21 is adapted to detect the presence of two marking tracks 22 made out of a predetermined material which is able to be detected by the sensor 21. These marking tracks may for instance be of circular form and of equal radius, and centered on axis X, each marking track 22 extending angularly on 90° and being angularly separated of the other marking track 22 by an angle of 90°.

For example, the marking tracks 22 may be constituted by reflective strips, whereas the sensor 21 is an optical sensor which is adapted to emit a light beam toward the pulley 23, said light beam being reflected by the reflective strips 22 when said strips are in register with the light beam, and the sensor further including an optical detector such as a phototransistor or similar in order to detect the reflected light beam.

In this particular example, the sensor 21 thus produces a two level square signal, with a frequency which is twice the rotation frequency of the of the crankshaft 24.

As shown in FIG. 4, this square input signal is transmitted to the input 20a of the controller 20, and this input signal is read by a frequency reader 25 and transmitted to a band pass filter 26 which also receives an output from the frequency reader 25.

The band pass filter 26 extracts at least one 10, harmonic of the rotation frequency, from the input signal, thus creating a filtered signal of sinusoidally varying AC voltage. In the embodiment considered here, the band pass filter 26 advantageously extracts, from the input signal, a filtered signal including the harmonic of orders 2 and 2.5 of the rotation frequency.

Besides, the output of the frequency reader is transmitted to a phase shift look up table 27, which controls a phase shifter 28 receiving the output of the band pass filter 26.

The phase shift look up table is adapted to determine a phase shift as a predetermined function of the rotation frequency. The look up table is determined in advance, for each type of vehicle, during tests in which the phase shift is varied for each rotation frequency so as to find the optimal phase shift, enabling to minimize the vibration of the transfer case or of another part of the vehicle.

Once the phase of the signal has been shifted in the face shifter, the signal is transmitted to an amplifier 30 which is controlled by an amplitude look up table 29 receiving the output of the frequency reader 25.

The amplitude look up table is adapted to determine the amplification of the signal as a predetermined function of the rotation frequency. This look up table is determined in advance, for each type of vehicle, during tests in which the amplification of the signal is varied for each frequency of the input signal so as to minimize the vibration. The amplified signal coming from the amplifier 30 goes to the output 20b of the controller 20, which itself feeds the coil 19 of the active mass absorber.

It should be noted that the controller 20 may be constituted by one or several circuits, including one or several digital circuits.

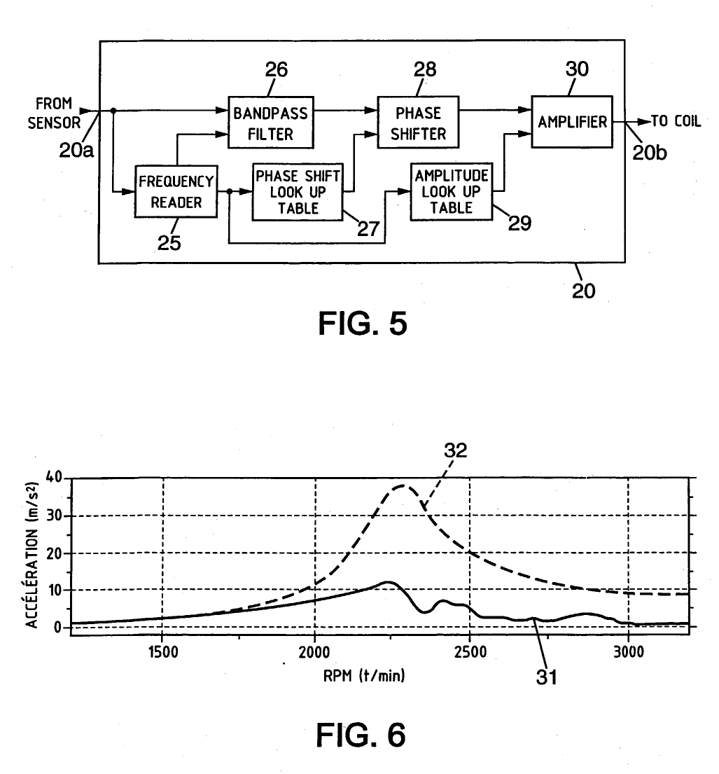

As shown in FIG. 5 (which represents the acceleration of the transfer case as a function of the rotation frequency of the motor for one particular vehicle), the acceleration diagram 31 of the transfer case when the active mass absorber is in operation, is much lower than the acceleration diagram 32 when the active mass absorber is not in operation, and this in the entire range of frequencies considered here (0-3250 rpm), which shows the efficiency of the invention. As a matter of fact, in the example considered herein, the frequency components of orders 2 and 2.5 of the rotation frequency generate a large proportion of the noise and vibrations felt by the driver and the passengers of the vehicle, for the usual range of speed of rotation of the motor. Such is the case in particular (but not exclusively) when these frequencies components are substantially close to the resonance frequencies of the pending mode of the powertrain, for instance between 2000 and 2500 rpm.

1. An antivibration apparatus for limiting vibrations of a vibrating element excited by at least a rotary assembly having a rotation frequency, said antivibration device including an active mass vibration absorber controlled by a controlling apparatus,
said active mass vibration absorber including a support which is designed to be fixed to the vibrating element, a mass and an electromagnetic actuator adapted to move said mass relative to said support as a function of a control signal received from said controlling apparatus,
said controlling apparatus including:
a sensor apparatus adapted to detect positions of the rotary assembly during rotation thereof,
and a controller adapted to:
extract a filtered signal including at least one harmonic of said rotation frequency, from an input signal which is received from said sensor apparatus,
determine a phase shift and an amplification as predetermined functions of said rotation frequency,
and determine said control signal by applying said phase shift and amplification to said filtered signal.

2. An antivibration apparatus as claimed in claim 1, wherein said filtered signal includes several harmonics of said rotation frequency.

3. An antivibration apparatus as claimed in claim 2, wherein said filtered signal includes two harmonics, respectively of orders 2 and 2.5, of the rotation frequency.

4. An antivibration apparatus as claimed in claim 1, wherein the sensor apparatus is adapted to generate said input signal, in the form of a square signal.

5. An antivibration apparatus as claimed in claim 1, wherein said controller is adapted to determine said phase shift and amplification through predetermined look up tables representing said predetermined functions.

6. An antivibration apparatus as claimed in claim 1, wherein said mass is a permanent magnet.

7. A vehicle comprising a motor which includes at least a rotary assembly having a rotation frequency, a vibrating element excited by said rotary assembly and an antivibration apparatus mounted on said vibrating element, said antivibration device including an active mass vibration absorber controlled by a controlling apparatus, said active mass vibration absorber including a support which is fixed to the vibrating element, a mass and an electromagnetic actuator adapted to move said mass relative to said support as a function of a control signal received from said controlling apparatus,
said controlling apparatus including
a sensor apparatus adapted to detect positions of the rotary assembly during rotation thereof,
and a controller adapted to:
extract a filtered signal including at least one harmonic of said rotation frequency, from an input signal which is received from said sensor apparatus,
determine a phase shift and an amplification as predetermined functions of a said rotation frequency,
and determine said control signal by applying said phase shift and amplification to said first filtered signal.

8. A vehicle as claimed in claim 7 wherein the motor drives a transfer case which itself drives front and rear wheels through front and rear shafts, and wherein the active mass absorber is mounted on the transfer case.
